(19) United States
(12) Patent Application Publication
(10) Pub. No.: US 2026/0101160 A1
(43) Pub. Date: Apr. 9, 2026

(54) MEASUREMENT SYSTEM, MEASUREMENT APPARATUS, AND ANALYSIS APPARATUS

(71) Applicant: Murata Manufacturing Co., Ltd., Nagaokakyo-shi (JP)

(72) Inventors: Motoyasu NAKAO, Nagaokakyo-shi (JP); Yuji NIHEI, Nagaokakyo-shi (JP); Yusuke YOSHIDA, Nagaokakyo-shi (JP)

(73) Assignee: Murata Manufacturing Co., Ltd., Nagaokakyo-shi (JP)

(21) Appl. No.: 19/414,565

(22) Filed: Dec. 10, 2025

Related U.S. Application Data
(63) Continuation of application No. PCT/JP2024/023457, filed on Jun. 28, 2024.

(30) Foreign Application Priority Data
Jul. 3, 2023 (JP) 2023-109443

(51) Int. Cl. H04W 4/38; H04W 56/00

(52) U.S. Cl. CPC H04W 4/38; H04W 56/005

(57) ABSTRACT

A measurement system includes a first measurement apparatus and a second measurement apparatus. Each apparatus includes a sensor that outputs a measurement signal, a wireless communication circuit that receives a trigger signal, and a synchronous sampling circuit. Each synchronous sampling circuit is configured to sample a both the trigger signal received and the measurement signal in synchronization with each other and output a synchronous trigger signal and a synchronous measurement signal. The wireless communication unit of each apparatus then transmits a signal pair including the synchronous trigger signal and the synchronous measurement signal.

### CROSS-REFERENCE TO RELATED APPLICATIONS

This application is a continuation of International Application No. PCT/JP2024/023457, filed on Jun. 28, 2024, which claims priority to Japanese Patent Application No. JP 2023-109443, filed on Jul. 3, 2023. The entire disclosures of the prior applications are hereby incorporated by reference in their entirety.

### TECHNICAL FIELD

The present disclosure relates to a measurement system using a plurality of sensors provided with a wireless communication function.

### BACKGROUND ART

In Patent Document 1, a biological signal measurement system is described. The biological signal measurement system in Patent Document 1 includes a plurality of terminals. The plurality of terminals each include a biological signal sensor that measures a biological signal.

Each of the biological signal sensors generates a sequence number indicating the order of acquisition of data based on a biological signal. Each of the terminals assigns a sequence number to data and transmits the data assigned with the sequence number to the other terminals. After receiving the sequence number, each of the other terminals resets the sequence number. Thus, synchronization between the plurality of terminals can be achieved.

In Patent Document 2, a biological information management system is described. The biological information management system in Patent Document 2 includes a biological information measurement unit, a timer unit, and a management server. The management server provides information indicating a standard time or information indicating a corrected time obtained by correction based on the information indicating the standard time to the timer unit.

The timer unit corrects, based on the information indicating the standard time or the information indicating the corrected time, the time at which the biological information measurement unit measured biological information. Thus, synchronization of biological information measured at different times can be achieved.

### CITATION LIST

### Patent Documents

Patent Document 1: International Publication No. 2014/033942

Patent Document 2: Japanese Unexamined Patent Application Publication No. 2008-178626

### SUMMARY

### Technical Problems

However, in the system described in Patent Document 1, resetting in each terminal generates a delay time. Furthermore, delay times in the individual terminals need to be the same. Thus, in the system in Patent Document 1, it is difficult to achieve, with simple configuration and simple processing, synchronization of data measured by a plurality of terminals.

Furthermore, in the system described in Patent Document 2, a delay regarding wireless communication of the information indicating the standard time and the information indicating the corrected time is not taken into consideration. Therefore, also in the system in Patent Document 2, it is difficult to achieve, with simple configuration and simple processing, synchronization of data measured by a plurality of terminals.

Accordingly, the present disclosure is directed to achieving, with simple configuration and simple processing, synchronization of data measured by a plurality of terminals.

### Solution to Problem

A measurement system according to an embodiment of the present disclosure includes a first measurement apparatus that includes a first sensor that outputs a first measurement signal and a first wireless communication unit, and a second measurement apparatus that includes a second sensor that outputs a second measurement signal and a second wireless communication unit. The first measurement apparatus includes a first synchronous sampling unit that samples a trigger signal received by the first wireless communication unit and the first measurement signal in synchronization with each other and outputs a first synchronous trigger signal and a first synchronous measurement signal. The first wireless communication unit transmits a first signal pair including the first synchronous trigger signal and the first synchronous measurement signal. The second measurement apparatus includes a second synchronous sampling unit that samples the trigger signal received by the second wireless communication unit and the second measurement signal in synchronization with each other and outputs a second synchronous trigger signal and a second synchronous measurement signal. The second wireless communication unit transmits a second signal pair including the second synchronous trigger signal and the second synchronous measurement signal.

With the configuration described above, the first measurement signal and the second measurement signal are sampled in synchronization with a common trigger signal. Thus, by referencing the trigger signal, synchronization between the first measurement signal and the second measurement signal can be achieved.

A measurement apparatus according to an embodiment of the present disclosure includes a sensor, a wireless communication unit, and a synchronous sampling unit. The sensor outputs a measurement signal. The wireless communication unit receives a trigger signal. The synchronous sampling unit samples the trigger signal received by the wireless communication unit and the measurement signal in synchronization with each other. The wireless communication unit transmits a signal pair including the trigger signal and the measurement signal that have been sampled in synchronization with each other.

With the configuration described above, the measurement signal that has been synchronized with the trigger signal is transmitted. Thus, in the case where a plurality of measurement apparatuses are present and there is an analysis apparatus that performs predetermined analysis based on measurement signals from the plurality of measurement apparatuses, the analysis apparatus is able to synchronize, based on the trigger signal, the measurement signals from the plurality of measurement apparatuses.

An analysis apparatus according to an embodiment of the present disclosure includes a trigger signal generation unit, a wireless communication unit, a synchronization processing unit, and an analysis unit. The trigger signal generation unit generates a trigger signal. The wireless communication unit transmits the trigger signal. The wireless communication unit receives a first signal pair including a first measurement signal that has been sampled in synchronization with the trigger signal and the trigger signal and a second signal pair including a second measurement signal that has been sampled in synchronization with the trigger signal and the trigger signal. The synchronization processing unit synchronizes the first measurement signal with the second measurement signal on the basis of the trigger signal included in each of the first signal pair and the second signal pair. The analysis unit analyzes events on the basis of the first measurement signal and the second measurement signal that have been synchronized with each other.

With the configuration described above, even when the first measurement signal and the second measurement signal that are different from each other and are generated based on events of an analysis target are received from the outside, the first measurement signal and the second measurement signal can be synchronized with each other based on the trigger signal. Thus, data analysis of events (how different types of responses or actions are associated with one other) can be achieved with high accuracy.

### Advantageous Effects

According to the present disclosure, with simple configuration and simple processing, synchronization of data measured by a plurality of terminals can be achieved.

### BRIEF DESCRIPTION OF DRAWINGS

FIG. 1 is a functional block diagram illustrating an example of a configuration of a measurement system according to a first embodiment.

FIG. 2 is a diagram illustrating relationship on the time axis among signals in the measurement system according to the first embodiment.

FIG. 3 is a functional block diagram illustrating an example of a configuration of a measurement apparatus according to a second embodiment.

FIG. 4 is a diagram illustrating an example of signals in the measurement apparatus according to the second embodiment.

FIG. 5 is a functional block diagram illustrating an example of a configuration of a measurement apparatus according to a third embodiment.

FIG. 6 is a diagram illustrating an example of signals in the measurement apparatus according to the third embodiment.

FIG. 7 is a functional block diagram illustrating an example of a configuration of a measurement apparatus according to a fourth embodiment.

### DESCRIPTION OF EMBODIMENTS

### First Embodiment

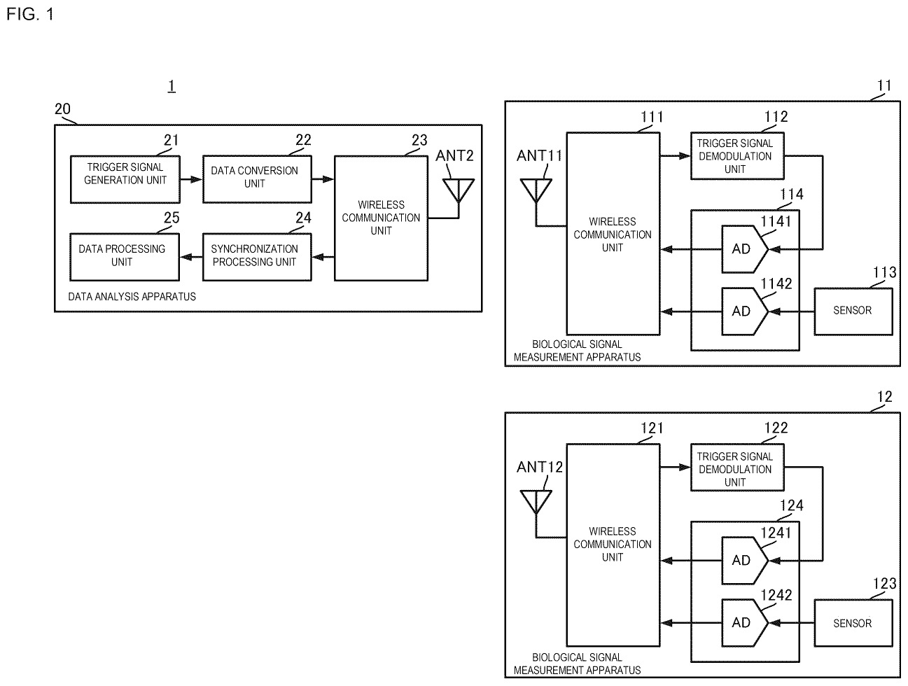

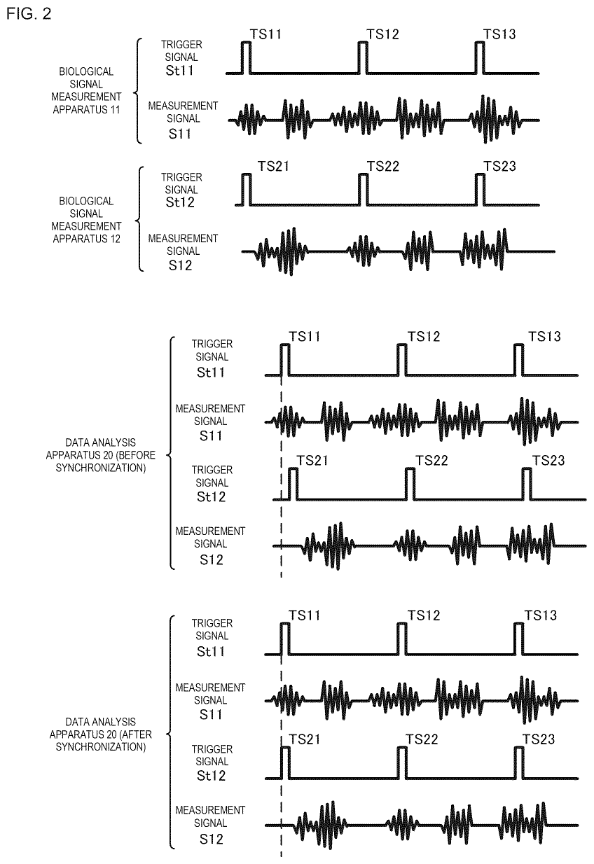

A measurement system according to a first embodiment will be described with reference to drawings. FIG. 1 is a functional block diagram illustrating an example of a configuration of the measurement system according to the first embodiment. FIG. 2 is a diagram illustrating relationship on the time axis among signals in the measurement system according to the first embodiment.

As illustrated in FIG. 1, a measurement system 1 includes a measurement apparatus 11, a measurement apparatus 12, and a data analysis apparatus 20. The measurement system 1 is a system that measures, using a single (common) trigger signal, a plurality of events occurred (for example, brain response, vocalization, body reaction, etc.) and performs predetermined data analysis while the events are synchronized with one another. In this embodiment, the case where the two measurement apparatuses are provided is illustrated. However, three or more measurement apparatuses may be provided.

The measurement apparatus 11 and the measurement apparatus 12 are, for example, apparatuses (portable apparatuses or wearable device, e.g., a head-mounted device, a wrist-worn device, etc.) of a size that can be worn by a subject. The measurement apparatus 11 and the measurement apparatus 12 may be apparatuses that externally measure movement of a subject. The measurement apparatus 11 and the measurement apparatus 12 correspond to a “first measurement apparatus” and a “second measurement apparatus” in the present disclosure. Hereinafter, for convenience of explanation, explanation will be provided under the assumption that the measurement apparatus 11 corresponds to the “first measurement apparatus” and the measurement apparatus 12 corresponds to the “second measurement apparatus.”

### (Configuration of Measurement Apparatus 11)

The measurement apparatus 11 includes a wireless communication unit 111, a trigger signal demodulation unit 112, a sensor 113, a synchronous sampling unit 114, and an antenna ANT11. As used herein, “unit” and “circuit” are interchangeable and refer to circuitry that may be configured via the execution of computer readable instructions, and the circuitry may include one or more local processors (e.g., CPU's), and/or one or more remote processors, such as a cloud computing resource, or any combination thereof.

The sensor 113 may be a sensor capable of measuring a vital signal of a subject, such as a voltage sensor or a potential sensor that measures brainwaves, or an acceleration sensor or a piezoelectric sensor that measures heart rate and blood pressure. Furthermore, the sensor 113 is not necessarily a vital sensor and may be a sensor that detects physical phenomena occurring in a measurement target, such as a temperature sensor, an optical sensor, or a vibration sensor.

The wireless communication unit 111, the trigger signal demodulation unit 112, and the synchronous sampling unit 114 are implemented by, for example, electronic circuits. The wireless communication unit 111 corresponds to a “first wireless communication unit” in the present disclosure, and the synchronous sampling unit 114 corresponds to a “first synchronous sampling unit” in the present disclosure. The sensor 113 corresponds to a “first sensor” in the present disclosure.

The antenna ANT11 connects to the wireless communication unit 111. The wireless communication unit 111 connects to the trigger signal demodulation unit 112 and the synchronous sampling unit 114. The sensor 113 connects to the synchronous sampling unit 114.

### (Configuration of Measurement Apparatus 12)

The measurement apparatus 12 includes a wireless communication unit 121, a trigger signal demodulation unit 122, a sensor 123, a synchronous sampling unit 124, and an antenna ANT12.

The wireless communication unit 121, the trigger signal demodulation unit 122, and the synchronous sampling unit 124 are implemented by, for example, electronic circuits. The wireless communication unit 121 corresponds to a “second wireless communication unit” in the present disclosure, and the synchronous sampling unit 124 corresponds to a “second synchronous sampling unit” in the present disclosure. The sensor 123 corresponds to a “second sensor” in the present disclosure. The sensor 123 has the same configuration as that of the sensor 113. The type of a signal that the sensor 123 measures and the type of a signal that the sensor 113 measures may be the same or different. For example, in the case where signals of the same type are measured, the sensor 123 and the sensor 113 are arranged at different positions of a measurement target. In the case where signals of different types are measured, the sensor 123 and the sensor 113 are arranged at the same position or different positions of a measurement target.

The antenna ANT12 connects to the wireless communication unit 121. The wireless communication unit 121 connects to the trigger signal demodulation unit 122 and the synchronous sampling unit 124. The sensor 123 connects to the synchronous sampling unit 124.

### (Configuration of Data Analysis Apparatus 20)

The data analysis apparatus 20 includes a trigger signal generation unit 21, a data conversion unit 22, a wireless communication unit 23, a synchronization processing unit 24, a data processing unit 25, and an antenna ANT2. The trigger signal generation unit 21, the data conversion unit 22, the wireless communication unit 23, the synchronization processing unit 24, and the data processing unit 25 are implemented by electronic circuits or arithmetic processing devices such as personal computers (PCs). The wireless communication unit 23 corresponds to a “third wireless communication unit” in the present disclosure.

The trigger signal generation unit 21 connects to the data conversion unit 22, and the data conversion unit 22 connects to the wireless communication unit 23. The wireless communication unit 23 connects to the antenna ANT2. The wireless communication unit 23 connects to the synchronization processing unit 24, and the synchronization processing unit 24 connects to the data processing unit 25.

### (Specific Processing of Measurement System 1)

### (Processing 1 of Data Analysis Apparatus 20)

The trigger signal generation unit 21 generates a trigger signal. The trigger signal is a signal of a frequency in an audible range and is an audio signal or a sound signal. The trigger signal includes a plurality of intermittent pulses repeated every predetermined period. The trigger signal generation unit 21 outputs the trigger signal to the data conversion unit 22.

The data conversion unit 22 performs data conversion from the trigger signal into a communication trigger signal and outputs the communication trigger signal to the wireless communication unit 23. The data conversion unit 22 may be omitted if the wireless communication unit 23 includes the function of the data conversion unit 22.

The wireless communication unit 23 transmits, through the antenna ANT2, the communication trigger signal. For example, the wireless communication unit 23 transmits the communication trigger signal, based on Bluetooth (registered trademark) LE Audio standards. Thus, the data analysis apparatus 20 is capable of implementing communication connection to the measurement apparatus 11 and the measurement apparatus 12, and at the same time, transmitting the communication trigger signal in a substantially synchronous manner. A method in which communication connection is not implemented (broadband transmission (distribution) of the communication trigger signal) may be employed. Other methods may be employed as long as the communication trigger signal can be transmitted in a substantially synchronous manner to the measurement apparatus 11 and the measurement apparatus 12.

### (Processing of Measurement Apparatus 11)

The wireless communication unit 111 receives, through the antenna ANT11, the communication trigger signal. The wireless communication unit 111 outputs the communication trigger signal to the trigger signal demodulation unit 112.

The trigger signal demodulation unit 112 demodulates the communication trigger signal into a trigger signal St11a. The trigger signal demodulation unit 112 outputs the trigger signal St11a to the synchronous sampling unit 114.

The sensor 113 detects a first event (response or action) of a subject and generates a measurement signal S11a corresponding to a result of the detection. The measurement signal S11a corresponds to a “first measurement signal” in the present disclosure. The sensor 113 outputs the measurement signal S11a to the synchronous sampling unit 114.

The synchronous sampling unit 114 includes a sampling device 1141 and a sampling device 1142. The sampling device 1141 and the sampling device 1142 perform AD sampling. AD sampling represents sampling an analog signal as a digital signal.

The sampling device 1141 digitally samples the trigger signal St11a and outputs a trigger signal St11 (first synchronous trigger signal). The sampling device 1142 digitally samples the measurement signal S11a and outputs a measurement signal S11 (first synchronous measurement signal).

The sampling device 1141 and the sampling device 1142 perform sampling in a synchronous manner. That is, the trigger signal St11 obtained by sampling by the sampling device 1141 and the measurement signal S11 obtained by sampling by the sampling device 1142 are synchronized with each other.

Furthermore, the sampling device 1141 performs sampling while attaching time information to the trigger signal St11. For example, as illustrated in FIG. 2, the sampling device 1141 performs sampling by attaching time stamps TS11, TS12, TS13, and so on to the signal.

The sampling device 1142 attaches time information or a counter value to the measurement signal S11 at the time of sampling. For example, a counter value that is incremented by one every time sampling is performed is saved together with the measurement signal S11 obtained by sampling.

The synchronous sampling unit 114 outputs the trigger signal St11 and the measurement signal S11 that have been obtained by synchronous sampling to the wireless communication unit 111. The trigger signal St11 and the measurement signal S11 provided with a counter value, which have been obtained by synchronous sampling, correspond to a “first signal pair” in the present disclosure. The trigger signal St11 and the measurement signal S11 are a collection of time-series data that have been obtained by multiple sampling operations over a certain period of time.

The wireless communication unit 111 converts the trigger signal St11 and the measurement signal S11 that have been obtained by synchronous sampling into a data format for wireless communication and transmits the converted trigger signal St11 and measurement signal S11 through the antenna ANT11. Even during a period in which a first signal pair cannot be obtained (a period in which a pulse part cannot be obtained), the wireless communication unit 111 transmits a counter value and the measurement signal S11.

### (Processing of Measurement Apparatus 12)

The wireless communication unit 121 receives, through the antenna ANT12, the communication trigger signal. The wireless communication unit 121 outputs the communication trigger signal to the trigger signal demodulation unit 122.

The trigger signal demodulation unit 122 demodulates the communication trigger signal into a trigger signal St12a. The trigger signal St12a is the same as the trigger signal St11a. The trigger signal demodulation unit 122 outputs the trigger signal St12a to the synchronous sampling unit 124.

The sensor 123 detects a second event (response or action) of the subject and generates a measurement signal S12a corresponding to a result of the detection. The measurement signal S12a corresponds to a “second measurement signal” in the present disclosure. The sensor 123 outputs the measurement signal S12a to the synchronous sampling unit 124.

The synchronous sampling unit 124 includes a sampling device 1241 and a sampling device 1242. The sampling device 1241 and the sampling device 1242 perform AD sampling.

The sampling device 1241 digitally samples the trigger signal St12a and outputs a trigger signal St12 (second synchronous trigger signal). The sampling device 1242 digitally samples the measurement signal S12a and outputs a measurement signal S12 (second synchronous measurement signal).

The sampling device 1241 and the sampling device 1242 perform sampling in a synchronous manner. That is, the trigger signal St12 obtained by sampling by the sampling device 1241 and the measurement signal S12 obtained by sampling by the sampling device 1242 are synchronized with each other.

Furthermore, the sampling device 1241 performs sampling while attaching time information to the trigger signal St12. For example, as illustrated in FIG. 2, the sampling device 1141 performs sampling by attaching time stamps TS21, TS22, TS23, and so on set inside the measurement apparatus 12 to the signal.

The sampling device 1242 attaches time information or a counter value to the measurement signal S12 at the time of sampling. For example, a counter value that is incremented by one every time sampling is performed is saved together with the measurement signal S12 obtained by sampling.

The synchronous sampling unit 124 outputs the trigger signal St12 and the measurement signal S12 that have been obtained by synchronous sampling to the wireless communication unit 121. The trigger signal St12 and the measurement signal S12 provided with a counter value, which have been obtained by synchronous sampling, correspond to a “second signal pair” in the present disclosure. The trigger signal St12 and the measurement signal S12 are a collection of time-series data that have been obtained by multiple sampling operations over a certain period of time.

The wireless communication unit 121 converts the trigger signal St12 and the measurement signal S12 that have been obtained by synchronous sampling into a data format for wireless communication and transmits the converted trigger signal St12 and measurement signal S12 through the antenna ANT12. Even during a period in which a second signal pair cannot be obtained (a period in which a pulse part cannot be obtained), the wireless communication unit 121 transmits the measurement signal S12.

### (Processing 2 of Data Analysis Apparatus 20)

The wireless communication unit 23 receives, through the antenna ANT2, the first signal pair of the trigger signal St11 and the measurement signal S11. The wireless communication unit 23 receives, through the antenna ANT2, the second signal pair of the trigger signal St12 and the measurement signal S12. The wireless communication unit 23 outputs the first signal pair and the second signal pair to the synchronization processing unit 24.

The synchronization processing unit 24 performs synchronization processing for the measurement signal S11 and the measurement signal S12 on the basis of time information of the trigger signal St11 and time information of the trigger signal St12. Specifically, the synchronization processing unit 24 adjusts positions on the time axis of the measurement signal S11 and the measurement signal S12 so that the time stamp TS11 of the trigger signal St11 and the time stamp TS21 of the trigger signal St12 match. With the use of time stamps, synchronization processing can be performed more reliably even when a signal pair cannot be obtained due to communication error or other reasons.

The synchronization processing unit 24 outputs the measurement signal S11 and the measurement signal S12 on which synchronization processing has been performed to the data processing unit 25.

The data processing unit 25 performs predetermined data processing on the basis of the measurement signal S11 and the measurement signal S12. The predetermined data processing represents, for example, processing for analyzing how different types of responses or actions of the subject are associated with one another.

With the configuration described above, even in the case where wireless communication in which the time for communication from the measurement apparatus 11 to the data analysis apparatus 20 and the time for communication from the measurement apparatus 12 to the data analysis apparatus 20 may be different is adopted, the data processing unit 25 can perform highly accurate data processing (analysis).

Specifically, for example, in the case of FIG. 2, the timing of the trigger signal St11 in the measurement apparatus 11 and the timing of the trigger signal St12 in the measurement apparatus 12 are substantially the same.

The measurement signal S11 is synchronized with the trigger signal St11, and the measurement signal S12 is synchronized with the trigger signal St12. Thus, at the time of measurement, the measurement signal S11 and the measurement signal S12 are substantially synchronized with each other.

However, at the time when the data analysis apparatus 20 receives the trigger signal St11 and the trigger signal St12 (before synchronization), the timing of the trigger signal St11 and the timing of the trigger signal St12 may be different from each other due to a difference between the state of communication with the measurement apparatus 11 and the state of communication with the measurement apparatus 12 or other reasons.

Thus, in the data analysis apparatus 20, the synchronization processing unit 24 performs synchronization processing for the trigger signal St11 and the trigger signal St12. The trigger signal St11 and the measurement signal S11 have been obtained by synchronous sampling and the trigger signal St12 and the measurement signal S12 have been obtained by synchronous sampling.

Thus, by achieving synchronization between the trigger signal St11 and the trigger signal St12, the measurement signal S11 and the measurement signal S12 are synchronized with each other. Accordingly, the data analysis apparatus 20 is able to reproduce the timing at which the measurement signal S11 was measured and the timing at which the measurement signal S12 was measured. In other words, the data analysis apparatus 20 is able to obtain the measurement signal S11 and the measurement signal S12 that were measured at the same time.

In the embodiment described above, the case where a trigger signal including pulses is continuously used every predetermined period has been described. However, a trigger signal including pulses may be used intermittently. Specifically, a trigger signal including pulses is continuously used every predetermined period during a first period, and no trigger signal is used during a second period. The first period and the second period are repeated. In this case, the measurement apparatus 11 generates and transmits a first signal pair during the first period and transmits only a measurement signal during the second period. Similarly, the measurement apparatus 12 generates and transmits a second signal pair during the first period and transmits only a measurement signal during the second period.

By understanding the relationship between time information or count values provided to the measurement signal S11 and the measurement signal S12 at the time when the trigger signal St11 and the trigger signal St12 are made synchronized with each other based on time information (for example, time stamps) during the first period, the time information or count values provided to the measurement signal S11 and the measurement signal S12 are compared during the second period so that synchronization can be achieved.

By repeating the first period and the second period every predetermined period, synchronous state can be updated periodically even in the case where internal clocks of the measurement apparatus 11 and the measurement apparatus 12 do not match. Specifically, with the use of time information (for example, time stamps) provided to pulses of the trigger signal St11 and the trigger signal St12, the relationship between time information or count values provided to the measurement signal S11 and the measurement signal S12 that are to be periodically synchronized with each other can be updated.

In the embodiment described above, a count provided to a measurement signal and a time stamp provided to a pulse of a trigger signal have been described as different indices. However, time information or count values of the measurement signal S11 and the measurement signal S12 and time information (for example, time stamps) of the trigger signal St11 and the trigger signal St12 may be the same. That is, for example, a count value that corresponds to a change point such as a pulse of a trigger signal from among count values may be used as a time stamp.

Furthermore, although not described in detail in the embodiment described above, a delay time Tdly regarding wireless communication between the measurement apparatuses 11 and 12 and the data analysis apparatus 20 may be measured in advance, and a period Ttrg of a trigger signal may be set based on the delay time Tdly. Specifically, the period Ttrg of a trigger signal is set longer than the delay time Tdly. Thus, a situation where a plurality of trigger signals are included in the delay time Tdly can be prevented.

Accordingly, more reliable synchronization can be achieved.

### Second Embodiment

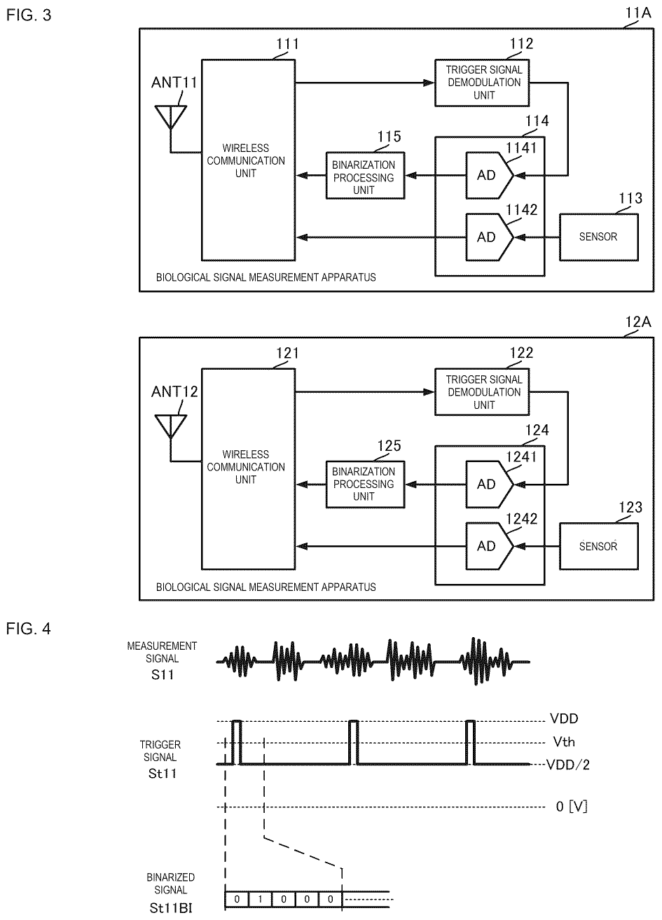

A measurement system according to a second embodiment will be described with reference to drawings. FIG. 3 is a functional block diagram illustrating an example of a configuration of a measurement apparatus according to the second embodiment. FIG. 4 is a diagram illustrating an example of signals in the measurement apparatus according to the second embodiment.

As illustrated in FIGS. 3 and 4, the measurement system according to the second embodiment is different from the measurement system 1 according to the first embodiment in the configuration of a plurality of measurement apparatuses and part of processing of a data analysis apparatus. Only features of the measurement system according to the second embodiment that are different from those of the measurement system 1 according to the first embodiment will be described below.

The measurement system according to the second embodiment includes measurement apparatuses 11A and 12A. The measurement apparatus 11A is different from the measurement apparatus 11 according to the first embodiment in that the measurement apparatus 11A includes a binarization processing unit 115. The measurement apparatus 12A is different from the measurement apparatus 12 according to the first embodiment in that the measurement apparatus 12A includes a binarization processing unit 125.

The binarization processing unit 115 and the binarization processing unit 125 each are implemented by, for example, an electronic circuit, a microcomputer, and the like. The binarization processing unit 115 and the binarization processing unit 125 have similar configuration and perform similar processing. Therefore, only processing of the binarization processing unit 115 will be described below in a concrete manner.

The binarization processing unit 115 binarizes the trigger signal St11 output from the sampling device 1141 to generate a binarized signal St11BI.

The binarization processing unit 115 sets and stores a binarization threshold value Vth for the trigger signal St11. The binarization processing unit 115 compares the trigger signal St11 with the threshold value Vth and generates the binarized signal St11BI.

At this time, the binarization processing unit 115 defines a period in which the voltage value of the trigger signal St11 is higher than the threshold value Vth (a period in which the voltage value is VDD in the drawing) as “1.” The binarization processing unit 115 defines a period in which the voltage value of the trigger signal St11 is lower than the threshold value Vth (a period in which the voltage value is VDD/2 in the drawing) as “0.”

By the processing described above, the trigger signal St11 is converted into the binarized signal St11BI of 2 bits. Thus, the amount of data transmission from the measurement apparatus 11A to the data analysis apparatus 20 can be reduced.

The data analysis apparatus performs synchronization processing for measurement signals on the basis of the binarized signal St11BI.

Thus, the amount of data communication as the measurement system can be reduced, and the communication data rate per measurement apparatus can be reduced. As a result, the number of measurement apparatuses that can connect to the data analysis apparatus can be increased.

Alternatively, in the case where the number of connecting apparatuses is fixed, the number of times of retransmission at the time of a wireless failure can be increased. Thus, the robustness of communication can be improved. With the configuration described above, synchronization between a plurality of measurement signals can be performed with high accuracy even when there is a failure in wireless communication from a measurement apparatus to the data analysis apparatus.

### Third Embodiment

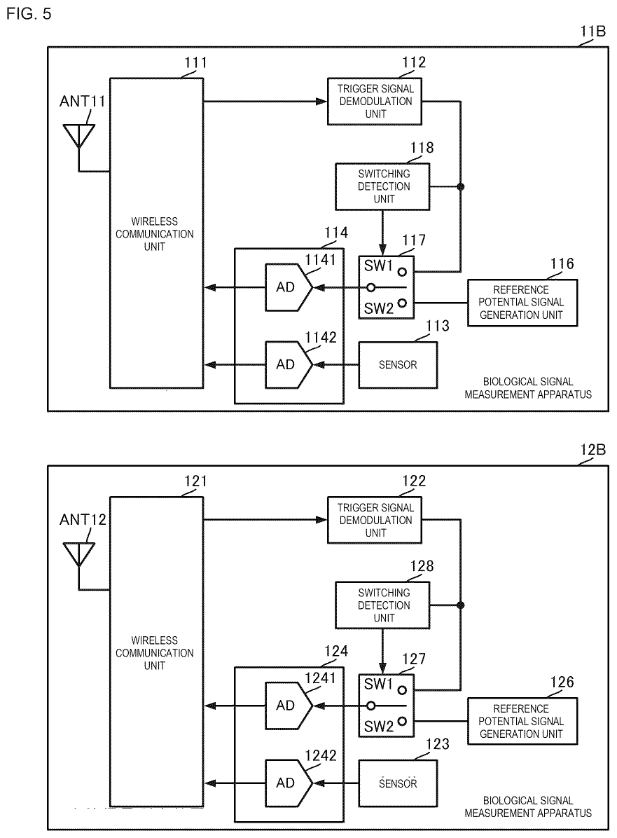

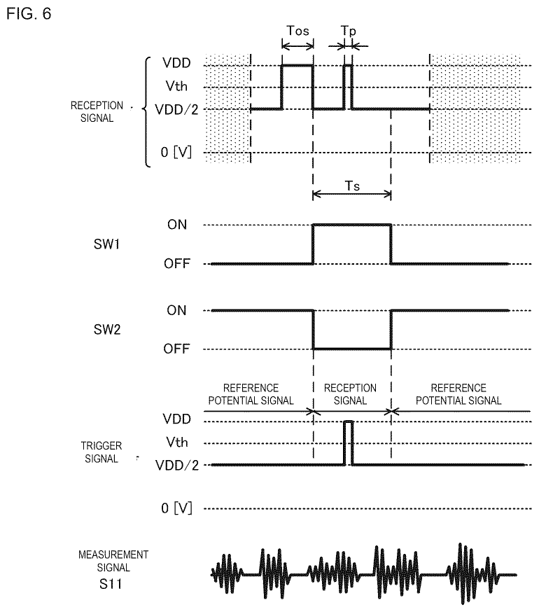

A measurement system according to a third will be described with reference to drawings. FIG. 5 is a functional block diagram illustrating an example of a configuration of a measurement apparatus according to the third embodiment. FIG. 6 is a diagram illustrating an example of signals in the measurement apparatus according to the third embodiment.

As illustrated in FIGS. 5 and 6, the measurement system according to the third embodiment is different from the measurement system 1 according to the first embodiment in the configuration of a plurality of measurement apparatuses. Only features of the measurement system according to the third embodiment that are different from those of the measurement system 1 according to the first embodiment will be described below.

The measurement system according to the third embodiment includes measurement apparatuses 11B and 12B. The measurement apparatus 11B is different from the measurement apparatus 11 according to the first embodiment in that the measurement apparatus 11B includes a reference potential signal generation unit 116, a switch circuit 117, and a switching detection unit 118. The measurement apparatus 12B is different from the measurement apparatus 12 according to the first embodiment in that the measurement apparatus 12B includes a reference potential signal generation unit 126, a switch circuit 127, and a switching detection unit 128. The measurement apparatus 12B has a configuration similar to that of the measurement apparatus 11B. Description of the configuration of the measurement apparatus 12B will be omitted.

The switch circuit 117 includes a first switch SW1 and a second switch SW2. The first switch SW1 and the second switch SW2 include a common terminal. The common terminal connects to an input terminal of the sampling device 1141. An individual terminal of the first switch SW1 connects to the trigger signal demodulation unit 112. An individual terminal of the second switch SW2 connects to the reference potential signal generation unit 116.

The switching detection unit 118 connects to an output terminal of the trigger signal demodulation unit 112 and connects to the switch circuit 117.

Unlike the trigger signal St11 in the first embodiment, a trigger signal St11B in this embodiment includes a switching signal before a pulse for synchronization on the time axis. The switching signal is a pulse signal. The pulse width Tos of the switching signal is greater than the pulse width Tp of the pulse for synchronization.

When detecting the switching signal, the switching detection unit 118 controls the first switch SW1 to be turned on and controls the second switch SW2 to be turned off during a predetermined period Ts from the time at which the switching signal falls. A time including the timing of the pulse for synchronization is set as the predetermined period Ts.

During the time other than the predetermined period Ts, the switching detection unit 118 controls the first switch SW1 to be turned off and controls the second switch SW2 to be turned on.

The reference potential signal generation unit 116 generates a direct-current reference potential signal. The voltage of the reference potential signal is set to the same voltage as a Low voltage of the trigger signal St11B. For example, in the case of FIG. 6, the voltage of the reference potential signal is set to VDD/2. The reference potential signal generation unit 116 outputs the reference potential signal to the second switch SW2 of the switch circuit 117. The reference potential signal generation unit 116 corresponds to a “first auxiliary signal generation unit” in the present disclosure, and a reference potential signal in the reference potential signal generation unit 116 corresponds to a “first synchronous auxiliary signal” in the present disclosure. The reference potential signal generation unit 126 of the measurement apparatus 12B corresponds to a “second auxiliary signal generation unit” in the present disclosure, and a reference potential signal in the reference potential signal generation unit 126 corresponds to a “second synchronous auxiliary signal” in the present disclosure.

With the configuration described above, during a period including a pulse for synchronization (a period in which a trigger signal including a pulse is received), the measurement apparatus 11B generates a first signal pair of a trigger signal and a measurement signal and transmits the first signal pair to the data analysis apparatus 20. In contrast, during a period not including a pulse for synchronization (a period in which a trigger signal including a pulse is not received), the measurement apparatus 11B generates a third signal pair of a reference potential signal and a measurement signal and transmits the third signal pair to the data analysis apparatus 20.

Similarly, during a period including a pulse for synchronization (a period in which a trigger signal including a pulse is received), the measurement apparatus 12B generates a second signal pair of a trigger signal and a measurement signal and transmits the second signal pair to the data analysis apparatus 20. In contrast, during a period not including a pulse for synchronization (a period in which a trigger signal including a pulse is not received), the measurement apparatus 12B generates a fourth signal pair of a reference potential signal and a measurement signal and transmits the fourth signal pair to the data analysis apparatus 20.

In the case where a wireless communication function for a trigger signal (for example, an audio signal) is operated intermittently, when communication of a trigger signal is not being performed, what signal is input to a synchronous sampling unit depends on the specifications of hardware of the measurement apparatus. Furthermore, at the time of switching operations such as start and stop of communication of a trigger signal, an unintentional signal may be generated. In contrast, with the use of a switching signal as in this embodiment, distortion of the waveform of a signal input to the synchronous sampling unit caused by start and stop of communication of a trigger signal can be avoided. Thus, the measurement apparatuses 11B and 12B can achieve stable synchronization.

The waveform of a reference potential signal is not limited to the example described above. For example, the voltage of a reference potential signal may be set to GND (0 V) instead of VDD/2. Furthermore, a switching signal is not limited to the example described above. For example, receiving certain rectangular waves a plurality of times may be set as a criterion for switching.

### Fourth Embodiment

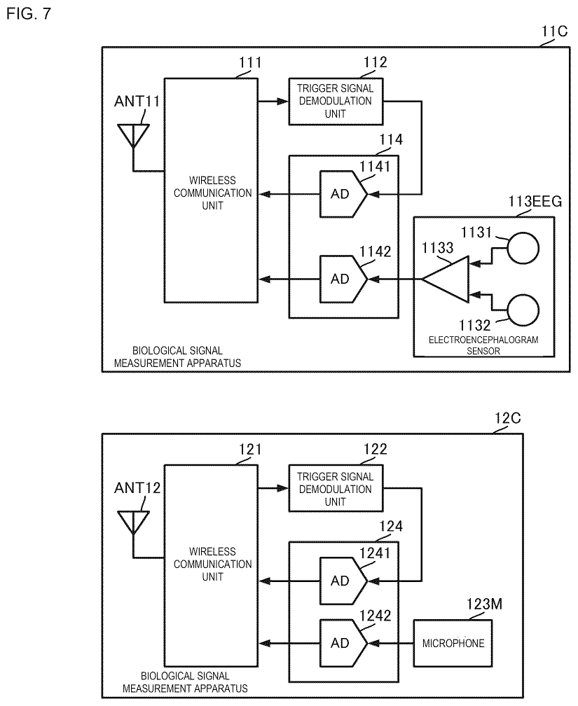

A measurement system according to a fourth embodiment will be described with reference to drawings. FIG. 7 is a functional block diagram illustrating an example of a configuration of a measurement apparatus according to the fourth embodiment.

As illustrated in FIG. 7, the measurement system according to the fourth embodiment is different from the measurement system 1 according to the first embodiment in the configuration of a plurality of measurement apparatuses. Only features of the measurement system according to the fourth embodiment that are different from those of the measurement system 1 according to the first embodiment will be described below.

The measurement system according to the fourth embodiment includes measurement apparatuses 11C and 12C. Unlike the measurement apparatus 11 according to the first embodiment, the measurement apparatus 11C includes an electroencephalogram sensor 113EEG instead of the sensor 113. Unlike the measurement apparatus 12 according to the first embodiment, the measurement apparatus 12C includes a microphone 123M instead of the sensor 123.

With the configuration described above, the measurement system is able to achieve accurate synchronization between an auditory stimulation signal (sensory stimulation signal) obtained by the microphone 123M and a result of measurement of brainwaves with respect to the auditory stimulation signal. Thus, the measurement system can improve accuracy of ERP measurement.

In this embodiment, the case where auditory stimulation is measured has been described. However, the measurement system according to this embodiment is also applicable to a system that measures sensory stimulation such as visual stimulation.

### Modifications

In the measurement system 1 according to the first embodiment, by using acceleration sensors as the sensor 113 and the sensor 123 and mounting the sensor 113 and the sensor 123 at different positions of the subject, motion measurement signals representing movement of the body at different positions can be obtained. By synchronizing these two sensors, movement of the entire body can be detected. The number of sensors is not limited to two. Also with three or more sensors, by synchronizing the sensors on the basis of a trigger signal in a similar manner to that described above, movement of the body at different positions can be detected. The acceleration sensors may be angular velocity sensors or magnetic sensors. Nine-axis sensors may be used.

In the embodiments of the present application, a function for generating a trigger signal, a function for synchronizing received signals, e.g., biological signals, and a function for performing analysis based on synchronized signals are performed in a single data analysis apparatus. However, these functions may be implemented in different apparatuses or part of these functions may be implemented in another apparatus.

<1> A measurement system comprising:
a first measurement apparatus that includes a first sensor that outputs a first measurement signal and a first wireless communication unit; and
a second measurement apparatus that includes a second sensor that outputs a second measurement signal and a second wireless communication unit,
wherein the first measurement apparatus includes
a first synchronous sampling unit that samples a trigger signal received by the first wireless communication unit and the first measurement signal in synchronization with each other and outputs a first synchronous trigger signal and a first synchronous measurement signal,
wherein the first wireless communication unit transmits a first signal pair including the first synchronous trigger signal and the first synchronous measurement signal,
wherein the second measurement apparatus includes
a second synchronous sampling unit that samples the trigger signal received by the second wireless communication unit and the second measurement signal in synchronization with each other and outputs a second synchronous trigger signal and a second synchronous measurement signal, and
wherein the second wireless communication unit transmits a second signal pair including the second synchronous trigger signal and the second synchronous measurement signal.

<2> The measurement system according to <1>, comprising:
an analysis apparatus including
a third wireless communication unit that receives the first signal pair and the second signal pair, and
a synchronization processing unit that synchronizes the first measurement signal with the second measurement signal on the basis of a time difference between the first synchronous trigger signal and the second synchronous trigger signal.

<3> The measurement system according to <2>,
wherein the analysis apparatus includes
a trigger signal generation unit that generates the trigger signal, and
an analysis unit that analyzes an event on the basis of the first measurement signal and the second measurement signal that have been made synchronized with each other by the synchronization processing unit, and
wherein the trigger signal is transmitted from the third wireless communication unit to the first wireless communication unit and the second wireless communication unit.

<4> The measurement system according to any one of <1> to <3>,
wherein the first measurement apparatus includes a first binarization processing unit that binarizes the first synchronous trigger signal output from the first synchronous sampling unit,
wherein the first synchronous trigger signal included in the first signal pair is a signal that is obtained by sampling by the first synchronous sampling unit and binarized by the first binarization processing unit,
wherein the second measurement apparatus includes a second binarization processing unit that binarizes the second synchronous trigger signal output from the second synchronous sampling unit, and
wherein the second synchronous trigger signal included in the second signal pair is a signal that is obtained by sampling by the second synchronous sampling unit and binarized by the second binarization processing unit.

<5> The measurement system according to <3>,
wherein the trigger signal generation unit intermittently generates trigger signals in such a manner that a period in which the trigger signal is generated and a period in which the trigger signal is not generated occur alternately,
wherein the third wireless communication unit performs transmission to the first wireless communication unit and the second wireless communication unit only during the period in which the trigger signal is generated,
wherein the first synchronous sampling unit generates the first signal pair when the trigger signal has been received,
wherein the first wireless communication unit transmits the first signal pair to the third wireless communication unit when the first signal pair has been generated,
wherein the second synchronous sampling unit generates the second signal pair when the trigger signal has been received, and
wherein the second wireless communication unit transmits the second signal pair to the third wireless communication unit when the second signal pair has been generated.

<6> The measurement system according to <5>,
wherein the first wireless communication unit continuously transmits the first measurement signal also during a period in which the trigger signal is not received, and
wherein the second wireless communication unit continuously transmits the second measurement signal also during the period in which the trigger signal is not received.

<7> The measurement system according to <5> or <6>,
wherein the first measurement apparatus includes a first auxiliary signal generation unit that generates an auxiliary signal with a waveform that is different from a waveform of the trigger signal,
wherein the first synchronous sampling unit outputs a first synchronous auxiliary signal and the first synchronous measurement signal by sampling the first auxiliary signal and the first measurement signal in synchronization with each other,
wherein the first wireless communication unit transmits a third signal pair including the first synchronous auxiliary signal and the first synchronous measurement signal to the third wireless communication unit during a period in which the first signal pair is not transmitted,
wherein the second measurement apparatus includes a second auxiliary signal generation unit that generates an auxiliary signal with a waveform that is different from the waveform of the trigger signal,
wherein the second synchronous sampling unit outputs a second synchronous auxiliary signal and the second synchronous measurement signal by sampling the second auxiliary signal and the second measurement signal in synchronization with each other, and
wherein the second wireless communication unit transmits a fourth signal pair including the second synchronous auxiliary signal and the second synchronous measurement signal to the third wireless communication unit during a period in which the second signal pair is not transmitted.

<8> The measurement system according to <7>, wherein the auxiliary signal is a direct-current reference potential signal.

<9> The measurement system according to any one of <1> to <8>, wherein the trigger signal is an audio signal.

<10> The measurement system according to any one of <1> to <9>,
wherein the first sensor is an electroencephalogram device, and the first measurement signal is an electroencephalogram signal, and
wherein the second sensor is a sensor that measures a response to sensory stimulation, and the second measurement signal is a sensory stimulation signal.

<11> The measurement system according to any one of <1> to <9>, wherein the first sensor is an acceleration sensor or an angular velocity sensor, the second sensor is an acceleration sensor or an angular velocity sensor, the first sensor and the second sensor are attached to different positions of a subject, and the first measurement signal and the second measurement signal are motion measurement signals for measuring movement of a body of the subject.

### REFERENCE SIGNS LIST

1 measurement system
11, 11A, 11B, 11C, 12, 12A, 12B, 12C measurement apparatus
20 data analysis apparatus
21 trigger signal generation unit
22 data conversion unit
23 wireless communication unit
24 synchronization processing unit
25 data processing unit
111, 121 wireless communication unit
112, 122 trigger signal demodulation unit
113, 123 sensor
113EEG: electroencephalogram sensor
114, 124 synchronous sampling unit
115, 125 binarization processing unit
116, 126 reference potential signal generation unit
117, 127 switch circuit
118, 128 switching detection unit
123M microphone
1141, 1142, 1241, 1242 sampling device
ANT11, ANT12, ANT2 antenna
S11, S12 measurement signal
St11, St11B, St12 trigger signal
St11BI binarized signal
SW1 first switch
SW2 second switch
VDD, VDD/2 voltage value
Vth threshold value

1. A measurement system comprising:
a first measurement apparatus that includes a first sensor that outputs a first measurement signal and a first wireless communication circuit; and
a second measurement apparatus that includes a second sensor that outputs a second measurement signal and a second wireless communication circuit,
wherein the first measurement apparatus includes
a first synchronous sampling circuit configured to sample a trigger signal received by the first wireless communication circuit and the first measurement signal in synchronization with each other and output a first synchronous trigger signal and a first synchronous measurement signal,
wherein the first wireless communication circuit is configured to transmit a first signal pair including the first synchronous trigger signal and the first synchronous measurement signal,
wherein the second measurement apparatus includes
a second synchronous sampling circuit configured to sample the trigger signal received by the second wireless communication circuit and the second measurement signal in synchronization with each other and outputs a second synchronous trigger signal and a second synchronous measurement signal, and
wherein the second wireless communication circuit is configured to transmit a second signal pair including the second synchronous trigger signal and the second synchronous measurement signal.

2. The measurement system according to claim 1, comprising:
an analysis apparatus including
a third wireless communication circuit configured to receive the first signal pair and the second signal pair, and
a synchronization processing circuit configured to synchronize the first measurement signal with the second measurement signal based on a time difference between the first synchronous trigger signal and the second synchronous trigger signal.

3. The measurement system according to claim 2,
wherein the analysis apparatus includes
a trigger signal generation circuit configured to generate the trigger signal, and
an analysis circuit configured to analyze an event based on the first measurement signal and the second measurement signal that have been made synchronized with each other by the synchronization processing circuit, and
wherein the trigger signal is transmitted from the third wireless communication circuit to the first wireless communication circuit and the second wireless communication circuit.

4. The measurement system according to claim 1,
wherein the first measurement apparatus includes a first binarization processing circuit configured to binarize the first synchronous trigger signal output from the first synchronous sampling circuit,
wherein the first synchronous trigger signal included in the first signal pair is a signal that is obtained by sampling by the first synchronous sampling circuit and binarized by the first binarization processing circuit,
wherein the second measurement apparatus includes a second binarization processing circuit configured to binarize the second synchronous trigger signal output from the second synchronous sampling circuit, and
wherein the second synchronous trigger signal included in the second signal pair is a signal that is obtained by sampling by the second synchronous sampling circuit and binarized by the second binarization processing circuit.

5. The measurement system according to claim 3,
wherein the trigger signal generation circuit configured to intermittently generate trigger signals in such a manner that a period in which the trigger signal is generated and a period in which the trigger signal is not generated occur alternately,
wherein the third wireless communication circuit is configured to transmit to the first wireless communication circuit and the second wireless communication circuit only during the period in which the trigger signal is generated,
in response to the trigger signal being received, the first synchronous sampling circuit is configured to generate the first signal pair,
in response to the first signal pair being generated, the first wireless communication circuit is configured to transmit the first signal pair to the third wireless communication circuit,
in response to the trigger signal being received, the second synchronous sampling circuit is configured to generate the second signal pair, and
in response to the second signal pair being generated, the second wireless communication circuit is configured to transmit the second signal pair to the third wireless communication circuit.

6. The measurement system according to claim 5,
wherein the first wireless communication circuit is configured to continuously transmit the first measurement signal also during a period in which the trigger signal is not received, and
wherein the second wireless communication circuit is configured to continuously transmit the second measurement signal also during the period in which the trigger signal is not received.

7. The measurement system according to claim 5,
wherein the first measurement apparatus includes a first auxiliary signal generation circuit configured to generate a first auxiliary signal with a waveform that is different from a waveform of the trigger signal,
wherein the first synchronous sampling circuit is configured to output a first synchronous auxiliary signal and the first synchronous measurement signal by sampling the first auxiliary signal and the first measurement signal in synchronization with each other,
wherein the first wireless communication circuit is configured to transmit a third signal pair including the first synchronous auxiliary signal and the first synchronous measurement signal to the third wireless communication circuit during a period in which the first signal pair is not transmitted,
wherein the second measurement apparatus includes a second auxiliary signal generation circuit configured to generate a second auxiliary signal with a waveform that is different from the waveform of the trigger signal,
wherein the second synchronous sampling circuit is configured to output a second synchronous auxiliary signal and the second synchronous measurement signal by sampling the second auxiliary signal and the second measurement signal in synchronization with each other, and
wherein the second wireless communication circuit is configured to transmit a fourth signal pair including the second synchronous auxiliary signal and the second synchronous measurement signal to the third wireless communication circuit during a period in which the second signal pair is not transmitted.

8. The measurement system according to claim 7, wherein the first auxiliary signal and the second synchronous auxiliary signal are each a direct-current reference potential signal.

9. The measurement system according to claim 1, wherein the trigger signal is an audio signal.

10. The measurement system according to claim 1,
wherein the first sensor is an electroencephalogram device, and the first measurement signal is an electroencephalogram signal, and
wherein the second sensor is a sensor that measures a response to sensory stimulation, and the second measurement signal is a sensory stimulation signal.

11. The measurement system according to claim 1,
wherein the first sensor is an acceleration sensor or an angular velocity sensor, and the second sensor is an acceleration sensor or an angular velocity sensor, and
wherein the first sensor and the second sensor are attached to different positions of a subject, and the first measurement signal and the second measurement signal are motion measurement signals for measuring movement of a body of the subject.

12. The measurement system according to claim 1, wherein the trigger signal includes a plurality of intermittent pulses repeated at a predetermined period.

13. A measurement apparatus comprising:
a sensor configured to output a measurement signal;
a wireless communication circuit configured to receive a trigger signal; and
a synchronous sampling circuit,
wherein the synchronous sampling circuit is configured to sample the trigger signal received by the wireless communication circuit and the measurement signal in synchronization with each other, and
wherein the wireless communication circuit is configured to transmit a signal pair including the trigger signal and the measurement signal that have been sampled in synchronization with each other.

14. The measurement apparatus according to claim 13, further comprising:
a binarization processing circuit configured to binarize the trigger signal sampled by the synchronous sampling circuit, wherein the trigger signal included in the signal pair is the binarized trigger signal.

15. The measurement apparatus according to claim 13, further comprising:
an auxiliary signal generation circuit configured to generate an auxiliary signal; and
a switch circuit configured to selectively provide one of the trigger signal and the auxiliary signal to the synchronous sampling circuit.

16. The measurement apparatus according to claim 13, wherein the synchronous sampling circuit is configured to attach time information to the sampled trigger signal.

17. An analysis apparatus comprising:
a trigger signal generation circuit configured to generate a trigger signal;
a wireless communication circuit configured to transmit the trigger signal and receive a first signal pair including a first measurement signal that has been sampled in synchronization with the trigger signal and the trigger signal and a second signal pair including a second measurement signal that has been sampled in synchronization with the trigger signal and the trigger signal;
a synchronization processing circuit configured to synchronize the first measurement signal with the second measurement signal on the basis of the trigger signal included in each of the first signal pair and the second signal pair; and
an analysis circuit configured to analyze events on the basis of the first measurement signal and the second measurement signal that have been synchronized with each other.

18. The measurement system according to claim 1, wherein the trigger signal included in each of the first signal pair and the second signal pair includes time information, and the synchronization processing circuit is configured to synchronize the first measurement signal with the second measurement signal by aligning the time information of the first signal pair with the time information of the second signal pair.

19. The measurement system apparatus according to claim 18, wherein the time information is a time stamp or a count value.

20. The measurement system according to claim 18, wherein the synchronization processing circuit is configured to synchronize the first measurement signal with the second measurement signal by adjusting positions on a time axis of the first and second measurement signals so that the time information of the first signal pair and the time information of the second signal pair match.
